(19) United States
(12) Patent Application Publication
(10) Pub. No.: US 2003/0229726 A1
(43) Pub. Date: Dec. 11, 2003

(54) Default device configuration system and method for thin devices

(76) Inventors: Michael J. Daseke, Dallas, TX (US); Kirk M. Lampert, Lewisville, TX (US)

Correspondence Address: Pillsbury Winthrop LLP, Intellectual Property Group, P.O. Box 10500, McLean, VA, 22102, US

(21) Appl. No.: 10/393,115

(22) Filed: Mar. 18, 2003

Related U.S. Application Data
(60) Provisional application No. 60/365,555, filed on Mar. 18, 2002.
(60) Provisional application No. 60/365,688, filed on Mar. 18, 2002.

(51) Int. Cl. G06F 13/10; G06F 15/173

(52) U.S. Cl. 709/321; 709/223

(57) ABSTRACT

A method for establishing a default client configuration for network addressable devices having multiple operating systems comprises identifying appropriate groups of devices, selecting appropriate software packages for downloading to the selected devices, and transmitting the selected packages to the selected devices over the network.

### RELATED APPLICATIONS

The present application claims the benefit of provisional patent application serial No. 60/365,555, entitled Dynamic Hierarchies System and Method for Thin Clients and provisional patent application serial No. 60/365,688, entitled Default Client Configuration System and Method for Thin Clients, both filed on Mar. 18, 2003, and naming as inventors the inventors of the present application. Both such applications are incorporated herein by reference, as is U.S. patent application Ser. No. ______, [attorney docket 093000/0302589] entitled Dynamic Hierarchies System and Method for Thin Devices, filed on even date herewith, assigned to the same assignee as the present application and naming the same inventors.

### SPECIFICATION

### FIELD OF THE INVENTION

The present invention relates generally to thin clients and related devices, and more particularly relates to a system and method for establishing default device configurations within a network of thin clients and related devices which permits automated processing of thin device images even in networks with multiple thin device platforms.

### BACKGROUND OF THE INVENTION

Thin clients have developed over the last decade as an alternative to networked PCs, to provide better centralized control of security and computing resources than is typically possible with a network of PCs. In addition, thin clients offer greater virus resistance, no moving parts to break down or lose data, reduced service costs, and more standardized connectivity without the rapid obsolescence of PCs.

To achieve these desirable features, a thin client typically maintains the primary computing functions on a server, rather than a local client such as a PC. In one example, the applications programs and data reside on the server and only displays are exchanged between the server and the client.

However, even with the advantages offered by thin clients, network management continues to exist. In particular, prior art thin client network management systems use static hierarchies. In a thin client static hierarchy as shown in FIG. 1, each thin client forms a node and a series of nodes is arranged in a fixed tree structure. Queries to the network cannot access clients on other branches of the tree. Thus, for example, an example of a static hierarchy might include a series of nodes arranged according to physical location—New York, Los Angeles, Munich, London and Tokyo. A subsidiary set of nodes for each location might be arranged by department, and thus include Accounting, Finance, and so on. In a conventional static hierarchy, a query which seeks to address all of the Finance thin clients in the entire network would need to include a query to each physical location, so that in our example five separate queries would be required. Conversely, if the network tree is designed along department lines, the tree might be arranged as, for example, Finance, Marketing, Administration, and so on. Then, for each branch relating to a department, a subsidiary branch would be required for each location, again New York, Los Angeles, London, Munich and Tokyo. While this hierarchy would make it straightforward to address all nodes in a particular department, it would be complicated to address all machines in a physical location because a query would have to be addressed to each department. Worse, to change from one form of network hierarchy to the other would require significant time and labor and would require, essentially, dismantling one hierarchy and reconstructing another.

This arrangement leads to additional disadvantages in the management of a network, particularly in the context of imaging the client. In conventional hierarchies, re-imaging must be done manually where the static hierarchy is not defined on a machine-type basis. Such a hierarchy is typically undesirable for most other purposes, and therefore is frequently not used. This arrangement leads to substantial manual effort, increasing labor costs as well as the possibility of error.

What has therefore been needed is a method and system by which a default client configuration can be established and propagated over a network even where the network includes a plurality of differently configured assets.

### SUMMARY OF THE INVENTION

The present invention overcomes the limitations of the prior art by establishing a default device configuration that allows the administrator to use an automated process to keep groups of devices up to date with a specific defined configuration. In the context discussed herein, devices will include thin clients, PDAs, bar code scanners, Point of Sale (POS) machines (e.g. cash registers), and cell phones.

In an exemplary arrangement of the present invention, the default device configuration process includes three steps:

Defining one or more Default Device Configurations

Assigning a specific Default Device Configuration to each Group of Devices

Device Reconciliation to image the device in accordance with the assigned configuration.

More particularly, the present invention defines one or more groups of devices, and then assigns a specific Default Device Configuration to each group of devices. This is accomplished by assigning the default configuration to Group Values of Group Types. Then devices that are assigned to the same Group Values will have the specified Default Device Configuration applied to them in the reconciliation process. As used herein, “device” will be understood to refer to a thin device.

The Default Device Configuration typically includes an image, which is typically an operating system, service packs, drivers, and some base applications such as an Internet browser, and may also include one or many additional software packages. The software packages can include applications, device drivers, and/or device configuration.

To achieve the goals of the present invention, and as discussed in greater detail in the Related Application, a “Group” is defined as part of the network infrastructure. The Group is defined in a manner such that the values associated with a Group are not locked to any particular level within the hierarchy. Instead the Group values are associated with a particular device. A View may then be requested where the View defines the manner in which one or more Groups of devices are displayed. Multiple methods of organizing device groups can be defined using different views.

By applying the concept of Groups to the default device configuration, each default configuration is defined for one or all group values for each Group Type, and devices are assigned to particular group values. For example, if a default configuration is defined for all the group values of a particular group type, all of the devices in that particular Group Type will receive a certain default configuration; if a default configuration is defined for only one or some of the group values of a particular group type, only those specified groups will receive that configuration. As a result, the Default Device Configuration can be applied to each of the appropriate devices.

The present invention may be better appreciated by the following detailed description, taken together with the appended figures as described below.

### THE FIGURES

FIG. 1 illustrates in process flow form the overall process of software package distribution.

FIG. 2 illustrates in flow diagram form the assignment of a default device configuration to a group of devices.

FIG. 3 illustrates from a user's view the data structure for assignment of a default device configuration.

FIG. 4 illustrates from a user's view the data structure for registering a package, image and/or configuration.

FIG. 5 illustrates from a user's view the data structure for identifying a software package.

FIG. 6 illustrates from a user's view reading a CE image from a device.

FIG. 7 illustrates from a user's view reading a CE bundled image.

### DETAILED DESCRIPTION OF THE INVENTION

The Default Device Configuration (DCC) system and method of the present invention work with the hierarchical structure of the Related Application to automate the updating and assignment of device configurations.

To better appreciate the foregoing, it is helpful to begin with some discussion of hierarchies. For convenience, the dynamic hierarchies of the Related Application are discussed herein, although dynamic hierarchies are not in all instances required for the present invention. To begin, a discussion of the concepts of Views, Device Groups and a Device Manager is helpful. A Group is a collection of devices that share the same attributes (e.g., physical location, operating system, or other characteristic). All Groups have a type called a Group Type that defines common attributes among Groups (e.g. City, Department). A Group Value is then assigned to a Group Type. Based on the Group Type and Group Value, Views define which Group Type represents each level in the tree hierarchy under the Device Manager, which is the management software program by which the system of the present invention is controlled. Each level in the tree control is of a specific Group Type (e.g. Department) and may contain any number of Device Groups of that type (e.g. Engineering, Sales, etc.).

In a presently preferred arrangement, multiple methods of organizing device groups can be defined using different views.

Group Types define common attributes among a network of devices, and may be any user-selected criteria, such as a functional group type (e.g. City, Department), or may be based on a characteristic of the particular thin device, such as processor, OS, media, and so on. Group types based on asset characteristics are built-in, which means that the devices are automatically grouped within these group types based on asset data from the device. Then, Group Values are assigned to the groups of devices within the Group Type, for example devices having similar media size or operating system. A DCC may be assigned to the groups according to the Group Value. As discussed hereinafter, a single device may belong to a plurality of groups, including built-in groups and user defined groups. Additionally, the user can create user-defined views. Views define which Group Type represents each level in the tree hierarchy under the Device Manager, with the overall definition for the particular view being referred to as a tree control. Each level in the tree control is of a specific Group Type (e.g. Department) and may contain any number of Groups of devices of that type (e.g. Engineering, Sales, etc.) with each different device Group having a different Group Value. In addition, each device typically has a Group Value for each Group Type, to allow for the dynamic re-ordering possible with the present invention.

In an exemplary embodiment, the various groups and views are maintained in a database, which may, for example, be in SQL Server. The Group Type and Group Value information in the database can be represented as a series of matrices, an example of which is shown in Tables A through D, below, as described in greater detail in the Related Application.

TABLE A
Group Type

| # | Description |
|---|---|
| 1 | Location |
| 2 | Department |
| 3 | Operating System |

TABLE B
Group Value

| Group Type # | Value | Value Description |
|---|---|---|
| 1 | 1 | Dallas |
| 1 | 2 | NYC |
| 1 | 3 | LA |
| 2 | 1 | R & D |
| 2 | 2 | Finance |
| 2 | 3 | Marketing |
| 2 | 4 | Legal |
| 3 | 1 | Win |
| 3 | 2 | Linux |
| 3 | 3 | Solaris |

TABLE C
Device Assignment

| Device | | |
|---|---|---|
| ID | Group Type # | Group Value # |
| 1 | 1 | 1 |
| 1 | 2 | 3 |
| 1 | 3 | 1 |
| 1 | 4 | 3 |
| 2 | 1 | 2 |
| 2 | 2 | 4 |
| 2 | 3 | 2 |
| 2 | 4 | 2 |
| 3 | 1 | 3 |
| 3 | 2 | 1 |
| 3 | 3 | 3 |
| 3 | 4 | 2 |

TABLE D
View

| View Title | Level | Group Type # |
|---|---|---|
| My View | 1 | 1 |
| My View | 2 | 2 |
| His View | 1 | 2 |
| His View | 2 | 1 |
| Her View | 1 | 3 |

Thus in Table A, three types of Groups are illustrated, although the number of types is solely exemplary and could be considerably greater. In the example of Table A, assume that a network manager is establishing hierarchies for a company that has offices in different cities, but also has devices spread throughout different departments. In addition, assume that the devices can use any of several operating systems and, most importantly for the present discussion, can be any of several default device configurations. Group Type 1 is defined to be location, while Group Type 2 is defined to be a department, and Group Type 3 is the operating system. Once the hierarchies are established, and the views defined, then the devices can be displayed according to the specific groups. At this point the default Device Configuration (DCC) can be applied.

The default device configuration, which is also maintained as a database, must take into account a variety of device parameters, including operating system, media size, whether the configuration includes only a basic image or an image plus software, and, finally, whether the software must be installed in a specific sequence. Thus, Table E shows one example of a Default Device Configuration:

TABLE E
Default Device Configuration

| # | Name | OS | Media Size | Image | Sequence? |
|---|---|---|---|---|---|
| 1 | DCC A | Win CE | 16 | Basic | No |
| 2 | DCC B | Linux | 16 | Basic + SW | Yes |
| 3 | DCC C | Solaris | 32 | Basic + SW | No |

The order in which software is installed is, in at least some arrangements, another feature, and can be appreciated from the Table F, below.

TABLE F
Software Order

| DCC # | Order | SW Pkg |
|---|---|---|
| 1 | 1 | WP |
| 1 | 2 | CAD |
| 2 | 1 | ACCTG |

In the example, DCC 1 first installs a word processing package, and then installs a CAD package. DCC 2, however, installs only an accounting package. It will be appreciated that these examples are simplified, and a typical DCC may include one to many software applications, including drivers and device configurations.

Finally, once the DCC and the software order are both defined, the groups of devices that will receive the specified DCC can be defined. In an exemplary arrangement, the DCC is applied by Group Value, although this arrangement need not be required in every instance. In this example, however, the hierarchies discussed in the Related Application are used to provide a tree control, which causes the desired Group Values to be displayed for each Group Type. Then, as shown in Table G, the specified DCC is applied to the specified Group Values.

TABLE G
DCC Application by Group Value

| DCC # | Group Type # | Group Value # |
|---|---|---|
| 1 | 1 | 2 |
| 1 | 2 | * |
| 2 | 1 | Not 2 |
| 2 | 3 | * |

From the first row of Table G, DCC 1 is used for the group of devices found in Group Value 2 of Group Type 1. Thus, using the example of Group Types and Values found in the Related Application, all devices in New York will get DCC 1. Likewise, from the second row of Table G, all departments get DCC 1; in the table, “*” is a wildcard, and thus means “all Group Values within the Group Type.” Referring to the third row, DCC 2 is applied to all of the Group Values of Group Type 1 except Group Value 2, so all devices in all locations except New York get DCC 2. From the last row in Table 4, DCC 2 is assigned to all Group Values within Group Type 3.

It will also be appreciated that, because a device typically is assigned a group value for each Group Type, multiple default configurations can apply to a single device. In this case, a selection is made as to which DCC should apply, and the remaining DCC's are ignored.

During the reconciliation process, each device is examined by the management application, for example the Rapport application offered by the assignee of the present invention, to ensure conformance with the assigned DCC. In the event that the comparison shows a mismatch, the DCC is reapplied. In some instances, a device is reallocated, or reassigned from one Group to another, such as by being relocated from one office to another or one department to another. In such a case, the new DCC is applied as the reallocated device is now assigned to a new Group Value. A related aspect of the reconciliation process is the need, if required by the DCC definition, to ensure that software sequence is maintained. Thus, suppose that two different Group Values have the same basic image, with the first DCC requiring a word processing package and the second DCC requiring a word processing package and a scanning package. In this example, the device is moved from the first Group Value to the second Group, such that it now needs the addition of the scanning package. Two results may eventuate: if sequence is not important, then the system will simply recognize the absence of the scanning package, add it, and finish. However, if sequence is important, then the device is at least partially reconfigured by adding the software packages in the required sequence.

Set forth below in pseudocode format, is a simplified exemplary sequence for establishing and changing Default Device Configurations, after the appropriate view has been defined for Group Type and Group Value.

### DEFAULT DEVICE CONFIGURATION

A Default Device Configuration allows the administrator to use an automated process to keep groups of devices up to date with a specific defined configuration.

The Default Device Configuration process include 3 steps:

Defining a Default Device Configurations

Assigning a Default Device Configuration to Groups of Devices

Device Reconciliation

### Defining a Default Device Configuration

A Default Device Configuration consists of an image and may also contain 1 or many additional software packages. The software packages contain applications, device drivers, and/or device configuration.

1. Create Default Device Configuration

IF User has permissions THEN

Define DCC Name

Select DCC Image

Select DCC SW Packages (if any)

Define if Package Order should be enforced

Update DB

ELSE

Error Message—Not authorized to Create DCC

END IF

### Assigning a Default Device Configuration

A Default Device Configuration is assigned to groups of devices. This is accomplished by assigning the default configuration to Group Values for Group Types. Then devices that are assigned the same Group Values will have the specified Default Device Configuration applied to them in the reconciliation process.

1. Assign Default Device Configuration

IF User has permissions THEN

Select Group Values for Each Group Type
IF does not conflict with existing DCC THEN

Update DB

ELSE

Error Message - Conflicting DCC's

END IF

ELSE

Error Message - Not authorized to Create DCC

END IF

### Device Reconciliation

The Device Reconciliation compares what is actually on the device versus what is defined in the Default Device Configuration. If a variance exists, Rapport will automatically perform the required updates.

1. Device Reconciliation

IF Device Image is NOT DCC Image OR Device has SW Packages not
in DCC THEN

Schedule Image
Schedule SW Packages

ELSE

IF Enforce DCC Sequence THEN

IF Order of Device SW Packages is NOT Order of DCC SW
Packages THEN

Schedule Image
Schedule SW Packages

END IF

ELSE

IF Device SW Packages NOT DCC SW Packages THEN

Schedule Missing SW Packages

END IF

END IF

END IF

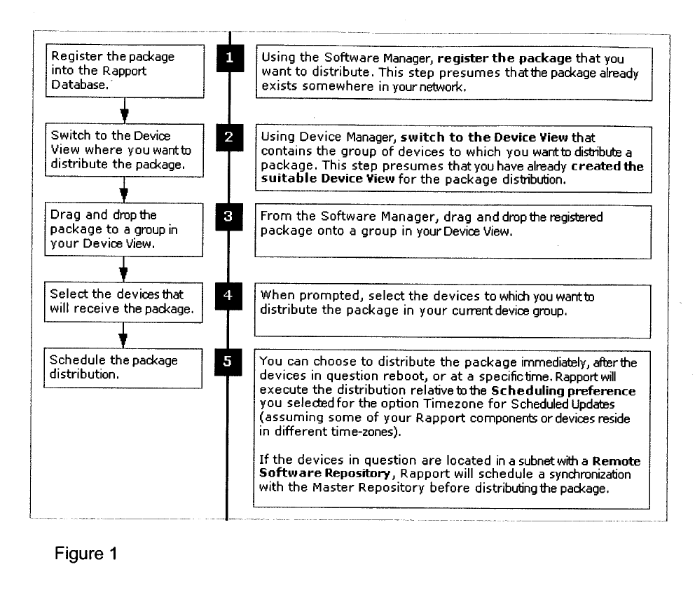

With the foregoing general discussion in mind, the detailed views of the Figures may be better appreciated. With reference initially to FIG. 1, an example of a drag and drop method of software package distribution, which is essentially a manual method of package distribution that is improved upon by the automated process of distribution discussed hereinafter.

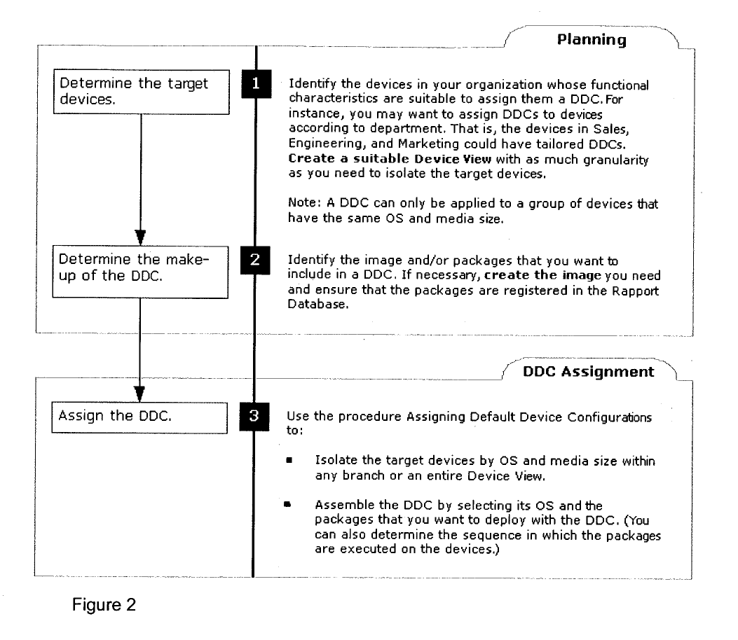

Referring next to FIG. 2, the process for assigning a default device configuration to a group of devices can be better appreciated. The process starts with two planning steps, as indicated at 200 and 210, involving identifying the target devices and determining the makeup of the default device configuration. The target devices are typically those which as sufficiently similar that they can benefit from identical imaging. In addition, identifying the packages which form the default configuration may involve developing an image for the target devices. The software packages should be available to be used in the default configuration by being registered with the database of the present invention.

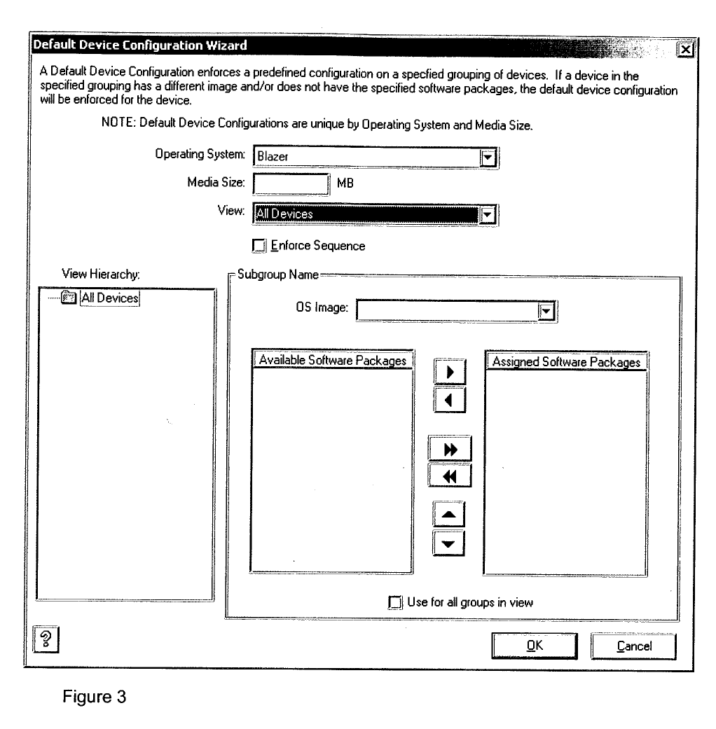

Once the target devices have been identified and the makeup of the default configuration determined, the DDC can be assigned as shown at 220 of FIG. 2. this procedure can be better appreciated from FIG. 3, which illustrates a pane 300 of the configuration manager which provides a method for a user to enter data into the database of the present invention. The pane 300 includes a field 310 for the Operating System associated with the DDC, and at 320 provides a list of the software packages available. The packages may then moved into the assigned list 330.

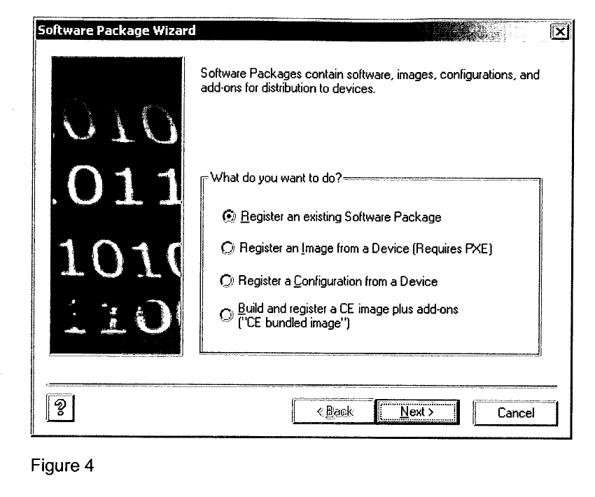

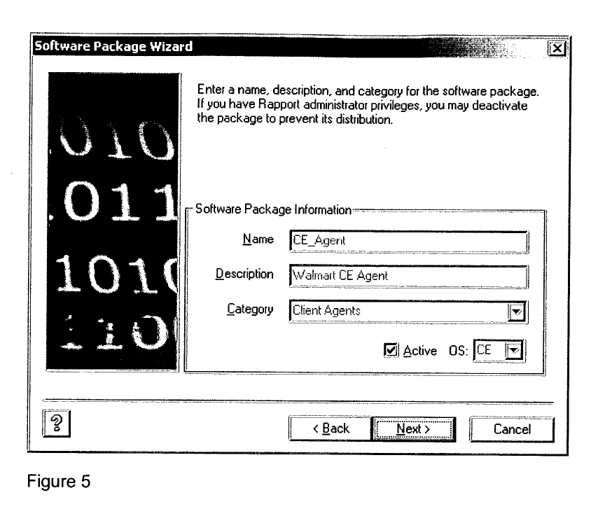

To be available to be assigned, the packages are typically registered with the database, which involves a process illustrated in FIG. 4. Registration can be for an existing package, an image from a device, a configuration, or a CE image plus add-ons, or what may be thought of as a bundled image. The process of registering a software package can be appreciated from FIG. 5, which illustrates from the user's view the data necessary to enter the package into the database of the present invention.

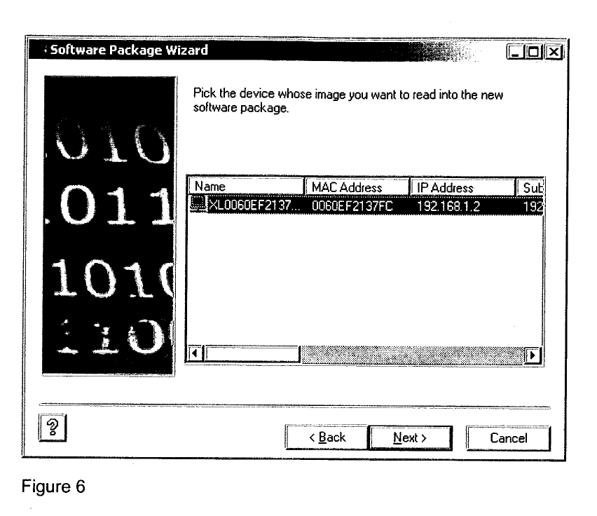

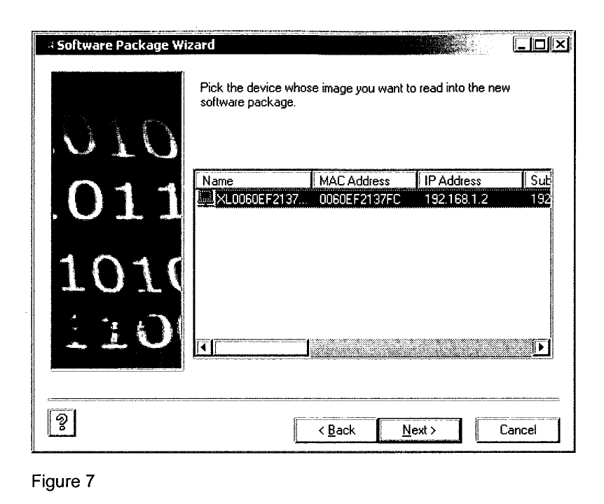

Similarly, FIG. 6 illustrates the data structures necessary for reading a device image into a software package in accordance with the present invention. FIG. 7 illustrates a similar structure for a CE bundled image.

It will therefore be appreciated that a new and novel method and system for establishing default device configurations among thin devices located in a network with different operating systems has been described, where multiple software components can be downloaded to the respective devices.

As noted above, further details of the present invention are illustrated in Appendix A, attached hereto and incorporated herein by reference.

Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A method for establishing a default device configuration comprising the steps of
identifying a plurality of similar devices addressable over a network
identifying a plurality of software components appropriate for downloading for each of a plurality of operating systems,
selecting at least some of the plurality of software components,
establishing a configuration comprising the plurality of software components,
transmitting the configuration to the plurality of similar devices.
